(19) United States
(12) Patent Application Publication
(10) Pub. No.: US 2011/0135001 A1
(43) Pub. Date: Jun. 9, 2011

(54) HIERARCHICAL MOTION ESTIMATION METHOD USING DYNAMIC SEARCH RANGE DETERMINATION

(75) Inventors: Shao-Sheng Yang, Kaohsiung City (TW); Wen-Yen Huang, Hsin-Chu City (TW); Chih-Yu Chang, Hsin-Chu City (TW)

(73) Assignee: Silicon Integrated Systems Corp., Hsinchu City (TW)

(21) Appl. No.: 12/632,580

(22) Filed: Dec. 7, 2009

(51) Int. Cl. H04N 11/02

(52) U.S. Cl. 375/240.16; 375/E07.026

(57) ABSTRACT

A hierarchical motion estimation method implemented in a plurality of levels is disclosed. The hierarchical motion estimation method is used for estimating motion vectors of a frame. The frame being partitioned into blocks at a first level, and each block of the first level is partitioned into a plurality of blocks at a second level. The method includes selecting reference blocks at the first level for a specific block at the second level and determining a search range for the specific block at the second level by referring to motion vectors, which are known, of the reference blocks at the first level. By using such a method, the motion vectors of a frame can be rapidly and accurately estimated.

### TECHNICAL FIELD OF THE INVENTION

The present invention relates to image processing, more particularly, to a motion estimation method for rapidly and accurately calculating motion vectors.

### BACKGROUND OF THE INVENTION

Motion estimation (ME) is a technique used in image compression, image recognition or the like to improve the frame rate of video. By using ME, a motion vector (MV) for a specific block between two frames can be estimated, so as to eliminate temporal redundancy between frames of a moving image and thereby improving image quality.

For image encoding using ME, it is not necessary that the motion vectors of the respective blocks of a frame are all correct. However, for frame rate up-conversion (FRC), the MV of each block of a frame must be correct so that the moving image can be smoothly displayed.

In the recent years, as liquid crystal screens have been widely used, FRC technique becomes important. FRC technique is to increase the frame rate of video so as to eliminate motion blur and movie film judder. By using FRC, the frame rate of the original video of film can be raised from 60 Hz to 120 Hz or even to 240 Hz, for example. To achieve the high frame rate, additional frames must be calculated. As mentioned, correct motion vectors between the original frames can be calculated by using motion estimation. The additional frames are interpolated between the original frames by using the motion vectors.

In order to rapidly and correctly estimate the motion vectors between the original frames, dynamic search range is applied in motion estimation so that the high resolution video encoding can be done in real time. Dynamic search range can also be applied in FRC to save calculation time and cost.

FIG. 1A shows a frame which is partitioned into nine blocks A to I. In this example, the block E is the current block to be estimated. According to prior art, for the current block E, the search range is determined with reference to the blocks A, B, C, D, of which the motion vectors have been calculated. The maximum motion vector components MV_{mX}, MV_{mY} in X-axis and Y-axis directions are found out from these periphery blocks. The search range for the current block E is determined by the maximum motion vector components MV_{mX}, MV_{mY}. These operations can be expressed as:

Block_{MVE}→Block_{MVA},Block_{MVB},Block_{MVC},Block_{MVD} (1)

MV_{mX}=max{abs(MV_{AX}),abs(MV_{BX}),abs(MV_{CX}),abs(MV_{DX})} (2)

MV_{mY}=max{abs(MV_{AY}),abs(MV_{BY}),abs(MV_{CY}),abs(MV_{DY})} (3)

Sometimes the search range is slightly extended by δ:

Search range of MV_{EX}=MV_{mX}+δ (4); and

Search range of MV_{EY}=MV_{mY}+δ (5).

When the motion vector of the current block is quite different from those of the periphery blocks, an error may occur in the motion estimation. FIG. 1B shows motion vectors of the respective blocks of the demonstration frame. In this case, the MV of a current block 5 is significantly greater than those of the peripheral blocks 1, 2, 3 and 4, which are all very small, for example. Such a condition will happen when an object moves fast in an approximately static background or large motion vector transition occurs at a moving object boundary, for example. As can be seen, the current block is estimated by using search ranges too small, and thereby resulting in a wrong motion vector. Therefore, it will be satisfactory if a more accurate motion estimation method can be provided.

### SUMMARY OF THE INVENTION

An objective of the present invention is to provide a hierarchical motion estimation method. The motion estimation is implemented in a plurality of levels. By using such a method, the motion vectors of a frame can be rapidly and accurately estimated.

In accordance with the present invention, the hierarchical motion estimation method is used for estimating motion vectors of a frame. The frame being partitioned into blocks at a first level, and each block of the first level is partitioned into a plurality of blocks at a second level. The method includes selecting reference blocks at the first level for a specific block at the second level; and determining a search range for the specific block at the second level by referring to motion vectors of the reference blocks at the first level. Before these steps, motion vectors of the reference blocks at the first level have been estimated with a first resolution.

If the first level is the lowest level in this method, that is, no previous level having with known motion vectors can be referred to, the motion vectors of the blocks of the first level are estimated by using a full search range with the first resolution.

After the search range for the specific block at the second level is determined, a motion vector of the specific block is estimated by using the determined search range with a second resolution. The second resolution is higher than the first resolution. In an embodiment of the present invention, the first resolution is one-quarter of the second resolution.

### BRIEF DESCRIPTION OF THE DRAWINGS

The present invention will be described in detail in conjunction with the appending drawings, in which:

FIG. 1A shows a frame which is partitioned into nine blocks, and FIG. 1B shows motion vectors of the respective blocks of the demonstration frame;

FIG. 2 schematically shows search ranges of the respective levels of the hierarchical motion estimation method in accordance with the present invention;

FIG. 3 shows a frame partitioned into blocks of Levelₖ and Levelₖ₋₁ in accordance with present invention;

FIG. 4 shows a full search range and a dynamic search range for a specific point on the frame;

FIG. 5 is a flow chart showing a hierarchical motion estimating method in accordance with the present invention; and

FIGS. 6A and 6B show a flow chart showing a motion vector estimation method using dynamic search range determination in accordance with the present invention.

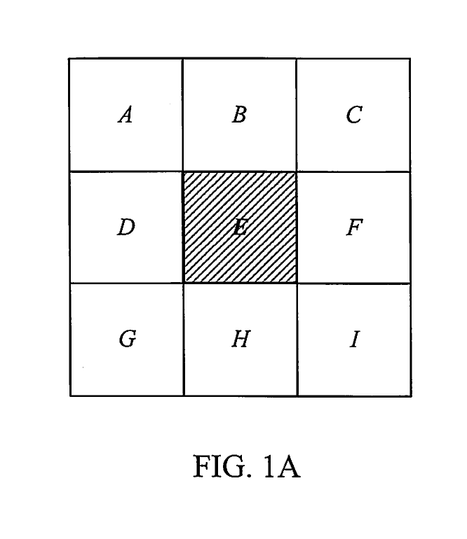

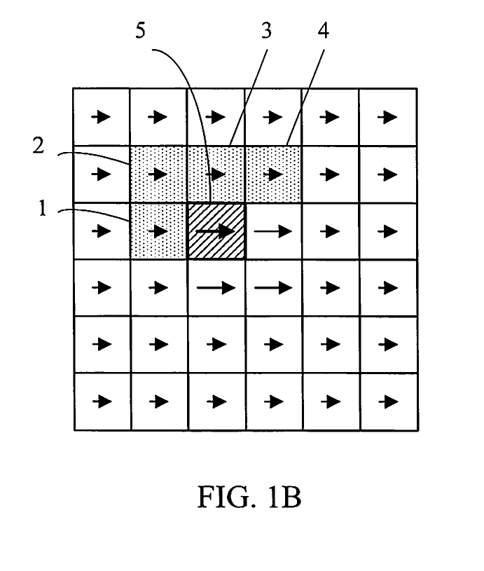

### DETAILED DESCRIPTION OF THE INVENTION

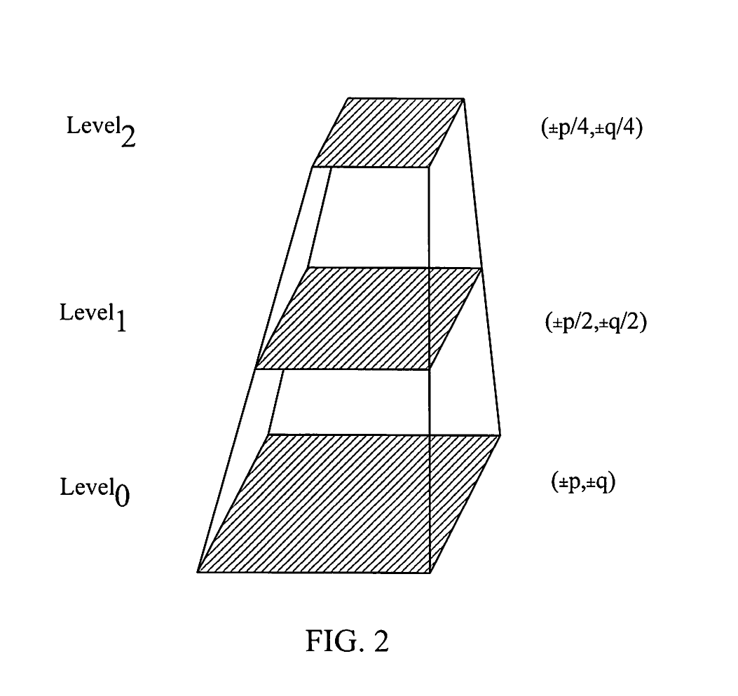

The present invention provides a hierarchical motion estimating method. FIG. 2 schematically shows search ranges of the respective levels of the hierarchical motion estimation method in accordance with the present invention.

According to this method, the motion estimation is executed by a plurality of levels. At the lowest level, a whole frame is coarsely partitioned into big blocks. For a block of the lowest level, a motion vector thereof is calculated by a full search range with a low resolution. Therefore, the actual search range of the lowest level is limited since the resolution is very low.

For a case in which the motion estimation is executed by three levels as shown in FIG. 2, the allowable maximum search ranges for the respective levels of each block will be described by using parameters p and q. As can be seen, if the maximum search range of the highest level Level₀ is ±p in X-direction, and ±q in Y-direction, Therefore the maximum complexity is (2p+1)×(2q+1) for each block. At Level₁, the maximum search range is ±p/2 in X-direction, and ±q/2 in Y-direction since the resolution of Level₁ is ¼ of that of Level₀. Therefore, the maximum complexity is (p+1)×(q+1) for each block. At Level₂, the maximum search range is ±p/4 in X-direction, and ±q/4 in Y-direction since the resolution of Level₂ is 1/16 of that of Level₀. Therefore, the maximum complexity is (p/2+1)×(q/2+1) for each block. For each block, if a dynamic search range determined by referring to motion vectors of the previous level exceeds the maximum search range thereof, the final search range for the current block is then selected as the maximum search range rather than the dynamic search range as in a normal condition. The time consumed for motion estimation is proportional to the square of the search range for each block. In the present invention, although the motion estimation is implemented by three levels, for example, the calculation for each level is of a very small quantity as compared to the conventional full search. Therefore, the motion estimation can be rapidly completed. Furthermore, for the higher levels, the motion vectors of the respective blocks are estimated with reference to the estimated motion vectors of the lower level, so that accurate final motion vectors can be estimated. The details will be further described later.

For example, for a 1366×768 frame, a search range denoted in X-direction and Y-direction (±32, ±18) for the conventional full search is required. If the motion estimation is executed by three levels as shown in FIG. 2, the maximum search range for the motion estimation executed at the highest level is (±32, ±18), the maximum search range for the motion estimation executed at the middle level is (±16, ±9), and the maximum search range for the motion estimation executed at the lowest level is (±8, ±4), since the resolution of the middle level is 4 times of that of the lowest level and the resolution of the highest level is 4 times of that of the middle level, Then, the motion estimation is firstly executed in full search (i.e. all the blocks of the entire frame) with the maximum search range (±8, ±4) at the lowest level (i.e. the first level Level₂), of which the resolution is 341×192, 1/16 of the original resolution 1366×768. As can be seen, the actual search range is only ¼ of the original full search range in one dimension. Since the resolution is very low, the calculation is not so complicated and can be completed rapidly even the calculation is executed to the whole frame.

The motion estimation for the second level (i.e. Level₁) is executed with a higher resolution 683×384 with the maximum search range (±16, ±9). At the second level Level₁, each block of the first level is further partitioned into four blocks. A dynamic search range of the second level Level₁ for every block is determined based on the motion vectors estimated at the lowest level (i.e. Level₂). It is noted that the dynamic search range should not exceed the maximum search range determined in the beginning as mentioned above. At the highest level (i.e. the third level Level₀), the dynamic search range of each block is determined based on the motion vectors estimated at Level₁, and the maximum search range is set as (±32, ±18), which is the normal resolution.

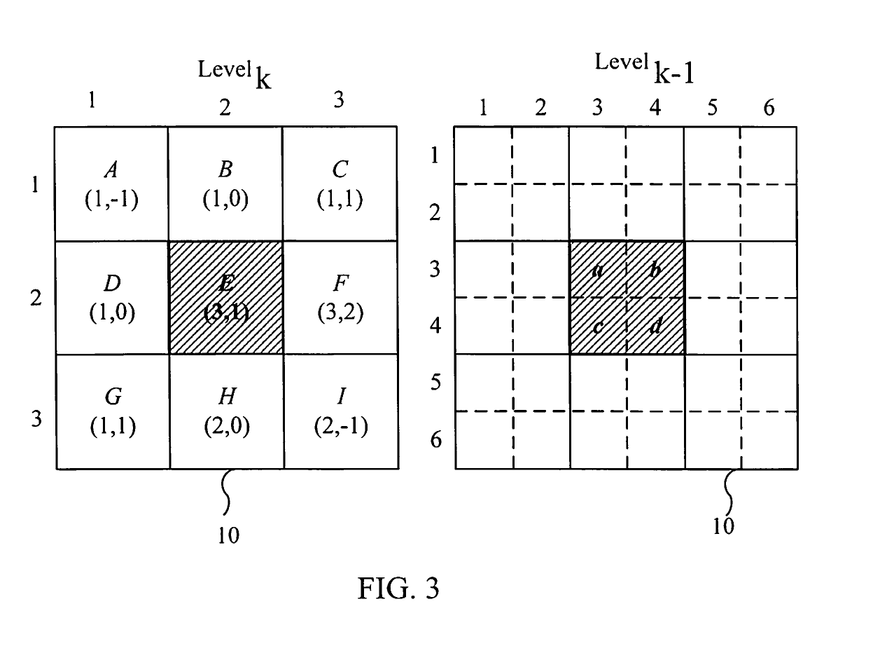

FIG. 3 shows a frame 10 partitioned into blocks of Levelₖ and Levelₖ₋₁ in accordance with present invention. In this drawing, Levelₖ is shown at the left side and Levelₖ₋₁ is shown at the right side. At Levelₖ, the frame 10 is partitioned into nine blocks A to I. In this embodiment, it is assumed that Levelₖ is the lowest level, and therefore motion vectors (MVs) of the respective blocks are estimated by using full search range with a low resolution. For example, the MV of the block E at the second row and the second column is (3, 1), that is MVₖ(2, 2)=(3, 1). The maximum search range for each block at Levelₖ is (±8, ±4).

At Levelₖ₋₁, each block of the frame 10 is further partitioned into four blocks. That is, the whole frame 10 is partitioned into 36 blocks at Levelₖ₋₁. For example, the block E is partitioned into four blocks a to d. For the current block a (i.e. the block at the third row and the third column), the motion vector MVₖ₋₁(3, 3) is estimated by searching, and the dynamic search range is determined by referring to the motion vectors of the relevant blocks at the previous level, Levelₖ. In the present application, the search range (SR) for estimating the motion vector of block a at Levelₖ₋₁ can be determined by referring to the motion vectors of the closest four blocks at Levelₖ, including the corresponding block (i.e. the block E at coordinate (2, 2)), the adjacent blocks (i.e. the blocks D and B at coordinates (2, 1) and (1, 2)) and the diagonal block (i.e. the block A at coordinate (1, 1)) at Levelₖ. This can be expressed as:

SRₖ₋₁(x,y)→MVₖ(x₁,y₁),MVₖ(x₂,y₂),MVₖ(x₃,y₃),MVₖ(x₄,y₄) (6)

wherein a coordinate of the specific block of the current level is (x, y); the four reference blocks respectively have coordinates (x1, y1), (x2, y2), (x3, y3) and (x4, y4) at the previous level, x1 to x4 and y1 to y4 are determined according to expressions of:

Δx=−2*(x MOD 2)+1 and Δy=−2*(y MOD 2)+1 (7)

x₁=[x/2],y₁=[y/2] (8),

wherein “[ ]” means a ceiling function, and “MOD” means a modulo operation.

x₂=[x/2]+Δx,y₂=[y/2] (9).

x₃=[x/2],y₃=[y/2]+Δy (10).

x₄=[x/2]+Δx,y₄=[y/2]+Δy (11).

As can be derived from the above expressions, for the block a at Levelₖ₋₁, x=3 and y=3, the search range SRₖ₋₁(3, 3) of the block a can be determined by referring to the motion vectors of the blocks A, B, D, E, which can be expressed as:

SRₖ₋₁(3,3)→MVₖ(2,2),MVₖ(1,2),MVₖ(2,1),MVₖ(1,1) (12)

According to the present invention, the search range SRₐ (i.e. SRₖ₋₁(3, 3)) of the block a is determined by the maximum X-direction MV component MV_{mX} and the maximum Y-direction MV component MV_{mY}.

MV_{mX}=max{abs(3),abs(1),abs(1),abs(1)}=3 (13)

MV_{mY}=max{abs(1),abs(0),abs(0),abs(−1)}=1 (14)

In the present embodiment, the resolution of Levelₖ is ¼ of that of Levelₖ₋₁. That is, a sampling rate for Levelₖ is ¼ of that for Levelₖ₋₁. Therefore, to calculate the dynamic search range SR, each maximum MV component should be multiplied by two. Furthermore, the search range can be slightly extended by δ, which can be zero or positive integer, in each dimension. In the present embodiment, δ is chosen as 1, therefore, the search range in X-direction SR_{aX} and the search range in Y-direction SR_{aY} for the block a are:

SR_{aX}=3×2+δ=3×2+1=7 (15)

SR_{aY}=1×2+δ=1×2+1=3 (16)

That is, for the block a, the dynamic search range is ±7 in X-direction, and is ±3 in Y-direction. Therefore, there will be 105 blocks to be compared ((14+1)×(6+1)=105). The full search range SR_{af} for the block a is (±16, ±9), resulting in 627 blocks to be compared. By using the method of the present invention in this case, 83.2% comparing time can be saved.

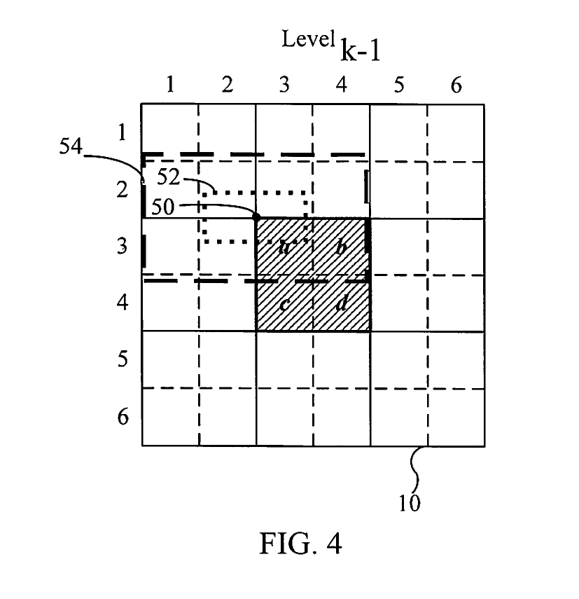

FIG. 4 shows a full search range and a dynamic search range for a specific point on the frame. For the upper left corner 50 of the block a, a full search range 54 (±16, ±9) is significantly larger than a dynamic search range 52 (±7, ±3).

Since correct motion vectors of the blocks A to I of Levelₖ can be obtained, the search range with a correct trend for each block of Levelₖ₋₁ can be effectively determined based on the motion vectors of Levelₖ. As described, the dynamic search range SRₐ of the block a at Levelₖ₋₁ is determined by referring to the motion vectors of the blocks A, B, D and E at Levelₖ. Similarly, a dynamic search range SR_{b} of the block b at Levelₖ₋₁ is determined by referring to the motion vectors of the blocks B, C, E and F at Levelₖ. A dynamic search range SR_{c} of the block c at Levelₖ₋₁ is determined by referring to the motion vectors of the blocks D, E, G and H at Levelₖ. A dynamic search range SR_{d} of the block d at Levelₖ₋₁ is determined by referring to the motion vectors of the blocks E, F, H and I at Levelₖ. For obtaining a more accurate motion vector, the dynamic search range can be slightly extended by a factor δ, which is zero or a positive integer, in each dimension. When δ equals to zero, it means that the search range is not extended outward.

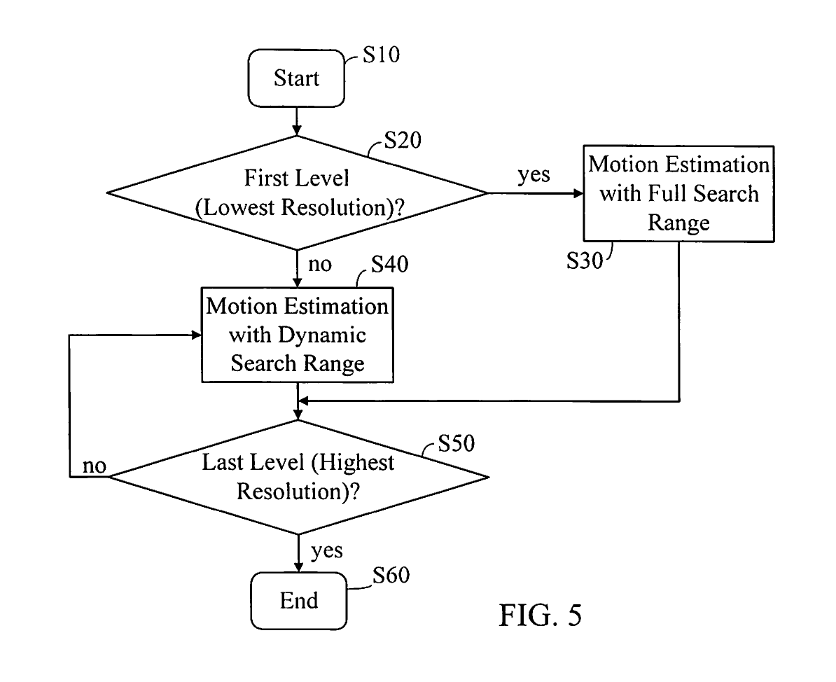

The method described above will be summed up with reference to FIG. 5, which is a flow chart showing the hierarchical motion estimating method in accordance with the present invention. The process starts at step S10. At step S20, it is determined whether a current level (i.e. the level where the block to be estimated is) is the first level or not. Alternatively, it is determined whether the resolution of the current level is the lowest resolution. If so, motion vectors of the respective blocks are estimated with the full search range (step S30). As described above, since the resolution of the first level is low, it will not take too much time to estimate the motion vectors even if the full search range is used. If not, it means that the current level is a higher level, and then the motion estimation is implemented with a dynamic search range (step S40). At step 50, it is determined whether the current level is the last level or whether the resolution of the current level is the highest resolution. If so, the motion estimation process is ended at step S60, otherwise, the process returns to step S40.

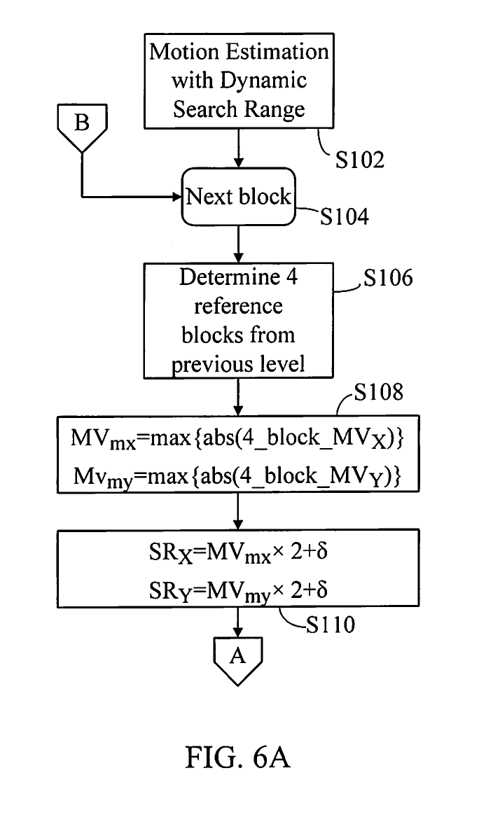

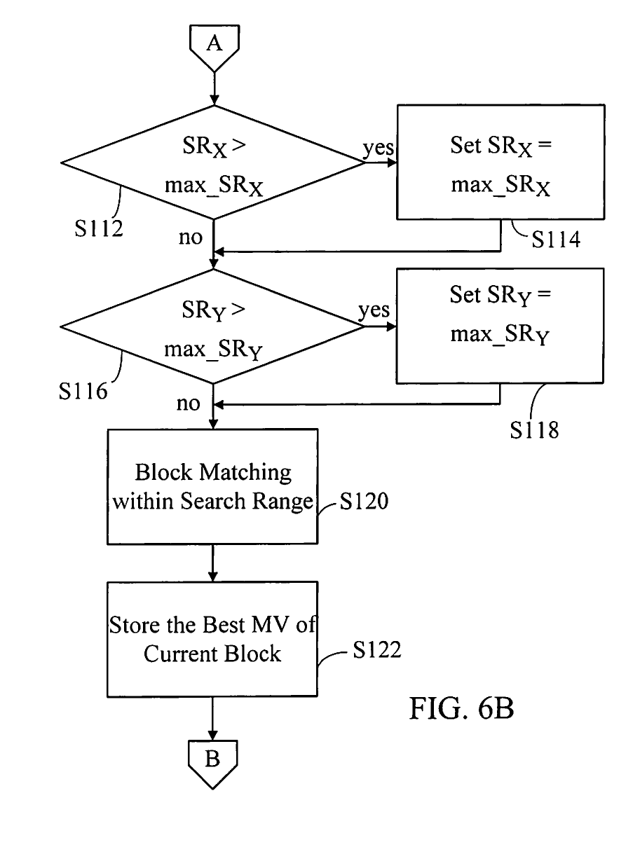

The motion estimation implemented with the dynamic search range will be further described with reference to FIGS. 6A and 6B, which show a flow chart showing a motion vector estimation method using dynamic search range determination (i.e. the step S40 of the method shown in FIG. 5) in accordance with the present invention. The process starts at step S102. At step S104, a block of the current level, which is not the lowest level, is selected as the current block (e.g. the block a of the level Levelₖ₋₁). In the current level, the blocks are defined by further partitioning blocks of the previous level. For example, if the current is Levelₖ₋₁, the blocks of Levelₖ₋₁ are obtained by partitioning each block of the previous level Levelₖ into four blocks. At this time, the selected current block of the current level Levelₖ₋₁ has not been calculated. The dynamic search range for estimating motion vector of this current block has not been determined. At step S106, reference blocks (e.g. the blocks A, B, D and E) of the previous level Levelₖ with respect to the current block are determined. In the embodiment described with reference to FIG. 3, reference blocks of the previous level (i.e. Levelₖ) for the selected block a of the current level (i.e. Levelₖ₋₁) are four blocks A, B, D and E, which are determined by using the expressions (7) to (11) listed above. As described, the motion vectors of the reference blocks are known since the motion estimation has been done to the previous level by using the full search range or dynamic search range. If the previous level is the lowest level, the motion estimation is done by using the full search range with a low resolution.

At step S108, the maximum motion vector components in X-direction and Y-direction among the reference blocks that are from step S106 are determined as:

MV_{mX}=max{abs(4_block_MV_{X})} (17)

MV_{mY}=max{abs(4_block_MV_{Y})} (18)

At step S110, the dynamic search range for the selected block to be estimated is determined by using the maximum MV components of the reference blocks. The dynamic search range SR thereof is determined as magnitudes in X-direction and Y-direction, which can be indicated by SR_{X} and SR_{Y} as follows:

SR_{X}=MV_{mX}×2+δ (19)

SR_{Y}=MV_{mY}×2+δ (20)

As mentioned, the maximum MV components of the reference blocks of the previous level should be respectively multiplied by two when calculating the dynamic search range since the resolution of the previous level is ¼ of that of the current level.

At step S112 and step S116, it is checked if the dynamic search range magnitudes in X-direction and Y-direction SR_{X} and SR_{Y} exceed thresholds max_SR_{X} and max_SR_{Y}, respectively. The thresholds max_SR_{X} and max_SR_{Y} are derived from the maximum search range determined in the beginning as described above. If the dynamic search range value SR_{X} exceeds the threshold max_SR_{X}, then the dynamic search value SR_{X} is set as the threshold max_SR_{X} (step S114). If the dynamic search range value SR_{Y} exceeds the threshold max_SR_{Y}, then the dynamic search value SR_{Y} is set as the threshold max_SR_{Y} (step S118). That is, the dynamic search range (±SR_{X}, ±SR_{Y}) is forced to be equal to a maximum search range (±max_SR_{X}, ±max_SR_{Y}), which is determined based on the resolution of the current level, when the determined dynamic search range exceeds the maximum search range. If the dynamic search range values do not exceed the thresholds, at step S120, then block matching is executed in the determined dynamic search range for the selected current block. That is, the motion vector of the selected current block is estimated by using a cost function, which can be an MSE (mean square error), SAD (sum of absolute difference) function or the like, within the determined dynamic search range. At step S122, the best estimated motion vector of the current block is stored, and the process returns to step S104 to estimate the motion vector of a next block.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A hierarchical motion estimation method for estimating motion vectors of a frame in a plurality of levels, the frame being partitioned into blocks at a previous level, and each block of the previous level being partitioned into a plurality of blocks at a current level, the method comprising:
selecting reference blocks at the previous level for a specific block at the current level; and
determining a search range for the specific block at the current level by referring to motion vectors of the reference blocks at the previous level,
wherein motion vectors of the reference blocks have been estimated with a previous resolution.

2. The method of claim 1, wherein the search range for the specific block at the current level is determined by referring to a maximum motion vector component in X-direction and a maximum motion vector component in Y-direction of the motion vectors of the reference blocks at the previous level.

3. The method of claim 1, wherein the search range for the specific block at the current level is further extended by a factor δ in X-direction and in Y-direction, δ is an integer equal to or greater than zero.

4. The method of claim 1, wherein each block at the previous level is partitioned into four blocks at the current level.

5. The method of claim 1, wherein the reference blocks at the previous level include four blocks which are the closest ones with respect to the specific block at the current level.

6. The method of claim 5, wherein the four reference blocks respectively have coordinates (x₁, y₁), (x₂, y₂), (x₃, y₃) and (x₄, y₄) at the previous level, x₁ to x₄ and y₁ to y₄ are determined according to expressions of:
Δx=−2*(x MOD 2)+1 and Δy=−2*(y MOD 2)+1;
x₁=[x/2],y₁=[y/2];
x₂=[x/2]+Δx,y₂=[y/2];
x₃=[x/2],y₃=[y/2]+Δy;
x₄=[x/2]+Δx,y₄=[y/2]+Δy,
where a coordinate of the specific block of the current level is (x, y), and “[ ]” means a ceiling function, and MOD means a modulo operation.

7. The method of claim 5, wherein the four reference blocks at the previous level include a first block at the previous level corresponding to the specific block at the current level, a second and a third blocks adjacent to the first block, and a fourth block which is diagonal to the first block and between the second and third blocks.

8. The method of claim 1, wherein the motion vector of each block of the previous level is estimated by using a full search range with the previous resolution, which is set as the lowest resolution, if the previous level is the lowest level in the method, the full search range is determined based on the lowest resolution.

9. The method of claim 1, further comprising estimating a motion vector of the specific block at the current level by using the determined search range with a current resolution, which is higher than the previous resolution.

10. The method of claim 9, wherein the previous resolution is one-quarter of the current resolution.

11. The method of claim 1, wherein the determined search range of the current level is forced to be equal to a maximum search range of the current level, which is determined based on a current resolution for the current level, when the determined search range exceeds the maximum search range.
